(19) United States
(12) Patent Application Publication
(10) Pub. No.: US 2003/0174358 A1
(43) Pub. Date: Sep. 18, 2003

(54) Printing system, printing program, computer-readable recording medium recorded with printing program, and printing method

(75) Inventor: Taiji Sasage, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/286,824

(22) Filed: Nov. 4, 2002

(30) Foreign Application Priority Data
Mar. 18, 2002 (JP) 2002-074482

(51) Int. Cl. G06F 15/00; B41B 1/00

(52) U.S. Cl. 358/1.15; 358/1.13

(57) ABSTRACT

A printing system, a printing program, a computer-readable recording medium recorded with the printing program, and a printing method, wherein when a user related to a print request has changed, one sheet of division paper on which a predetermined pattern is marked on the margin thereof is printed, so that printed matter for each user can be easily sorted.

### FIELD OF THE INVENTION

The present invention relates to a technique for facilitating the sorting of printed matter for each user in a printing apparatus which is shared so as to be usable by a plurality of users, such as a network printer.

### RELATED ART OF THE INVENTION

Heretofore, there is known a network printer which is connected to a network such as a LAN (Local Area Network), and shared so as to be usable by a plurality of users. In the network printer, a scheme is adopted where, when print requests are output from a plurality of users simultaneously, data thereof is temporarily stored in a printer server, after which printing is sequentially executed.

However, in the network printer, since printing is executed sequentially corresponding to print requests from a plurality of users, the printed matter for the plurality of users sometimes becomes mixed in the paper-out tray. Then, since division of the printed matter for each user is unclear, it is difficult to recognize whether or not the printed matter of other users is mixed, causing problems in that this is often mistakenly taken.

Therefore, the present invention takes into consideration the above mentioned heretofore problems, with the object of providing a printing technique which facilitates the sorting of printed matter for each user, by printing one sheet of division paper on which an arbitrary pattern is marked, when the user related to a print request has changed.

### SUMMARY OF THE INVENTION

In order to achieve the above object, a printing technique according to the present invention is characterized in that, when a user related to a print request has changed, data for division paper on which a predetermined pattern is marked on the margin thereof is inserted into print data, and is then printed. At this time, when a printing apparatus is a separate one, the print data into which division paper data has been inserted may be output to the printing apparatus.

According to such a construction, when a user related to a print request has changed, one sheet of division paper marked with a predetermined pattern on the margin is inserted to the printed matter. Consequently, by merely flipping the edge of the printed matter, it becomes easy to sort printed matter for oneself from that of others, and hence the mistaking of printed matter of others can be avoided. Moreover, since the division paper is printed using a print function of a printer or the like, printing can be realized even with a printing apparatus that has only one paper-feed tray. Hence the cost for constructing a printing system can be suppressed.

Furthermore, an arbitrary pattern associated with a user is registered, and if a pattern for a user related to a print request is registered, it is desirable to mark the pattern on the margin of the division paper.

According to such a construction, a pattern corresponding to a user related to a print request is marked on the division paper. Therefore, even when printed matter of a plurality of users is accumulated in a paper-outlet tray, it is possible to easily sort ones own printed matter.

Furthermore, it is desirable to register optional data to be marked on the division paper, so that this data can be inserted into the division paper data. At this time, it is preferable to be able to set the number of times for marking the optional data on the division paper.

According to such a construction, since optional data can be arbitrarily marked on the division paper, it is possible for a user to convey a message urging, for example, someone using the same printing apparatus who might take mistakenly user's printed matter, to return that printed matter. Moreover, it is also possible to notify arbitrary messages such as mistaking, or maintenance information and the like to the person requesting printing. At this time, if the number of times for marking optional data is arbitrarily set, such a situation where optional data is marked ad infinitum can be avoided.

Other objects and aspects of this invention will become apparent from the following description of embodiments in conjunction with the appended drawings.

### BRIEF EXPLANATION OF THE DRAWINGS

FIG. 1 shows a printing system constructed by applying the present invention to a printer server, in which (A) is a block diagram of a first embodiment and (B) is a block diagram of a second embodiment.

FIG. 2 shows patterns to be printed at the margin of division paper, in which (A) to (D) are explanatory diagrams of patterns 0 to 3, respectively.

FIG. 3 is an explanatory diagram of an optional data table.

FIG. 4 shows optional data for printing onto division paper, in which (A) to (D) are explanatory diagrams for conditions where optional data is marked on patterns 0 to 3, respectively.

FIG. 5 shows a continuity determination table, in which (A) is an explanatory diagram for when a continuity flag is set to 0 and (B) is an explanatory diagram for when the continuity flag is set to 1.

FIG. 6 is an explanatory diagram of a division paper pattern table.

FIG. 7 is a flow chart of a main routine to be executed at a printer server.

FIG. 8 is a flow chart of a subroutine for executing continuity determination processing.

FIG. 9 is a flow chart of a subroutine for executing division paper insertion processing.

FIG. 10 is an explanatory diagram of printed matter to which division paper has been inserted.

### PREFERRED EMBODIMENT

As follows is a detailed description of the present invention with reference to the appended drawings.

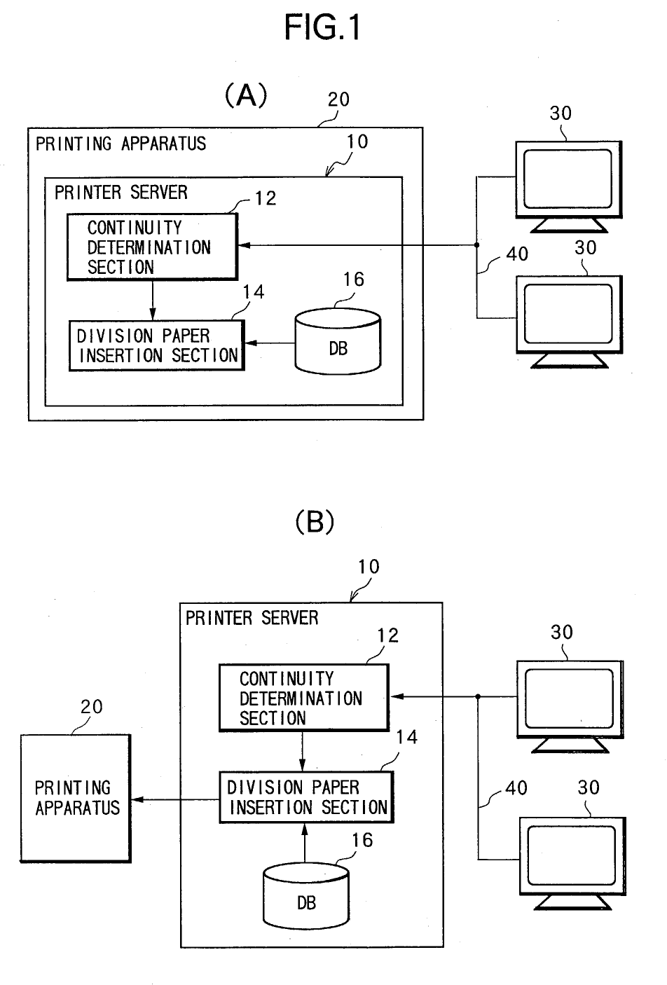

FIG. 1 shows an embodiment where a printing technique according to the present invention is applied to a printer server, to construct a printing system on a network such as a LAN.

The printing system comprises, as shown in (A) of FIG. 1, a printing apparatus 20 incorporating a printer server 10 therein, or as shown in (B) of FIG. 1, a printer server 10 as a dedicated apparatus and a printing apparatus 20. Moreover, a plurality of clients 30 serving as user terminals are connected through a network 40 to the printer server 10. Printing means, a printing function and a printing step are realized by the printing apparatus 20 and the control thereof.

Here, each of the printer server 10 and the client 30 comprises a computer having a central processing unit (CPU) and a memory, and various functions are realized by a program loaded in the memory. The printing system may have a construction where one client 30 is used alternately by a plurality of users.

In the printer server 10, there is installed a continuity determination section 12, a division paper insertion section 14 and a DB (Database) 16. Here, continuity determination means, a continuity determination function and a continuity determination step are realized by the continuity determination section 12. Furthermore, division paper insertion means, a division paper insertion function and a division paper insertion step are realized by the division paper insertion section 14. Moreover, in the construction shown in (B) of FIG. 1, print data output means, a print data output function and a print data output step are realized by the division paper insertion section 14. In addition, pattern registration means, optional data registration means and number of times setting means are realized by the DB 16 and/or the registration (setting) processing thereof.

In the continuity determination section 12, when a print request is made by the client 30, it is determined whether a user related to the print request (referred to hereunder as “print request user”) has changed or not. In the division paper insertion section 14, when it is determined in the continuity determination section 12 that the print request user has changed, data for division paper on which a predetermined pattern is printed on the margin thereof, is inserted into the print data. On the other hand, in the DB 16, there is respectively registered, pattern data for a pattern to be marked on the division paper, an optional data table, a continuity determination table and a division paper pattern table.

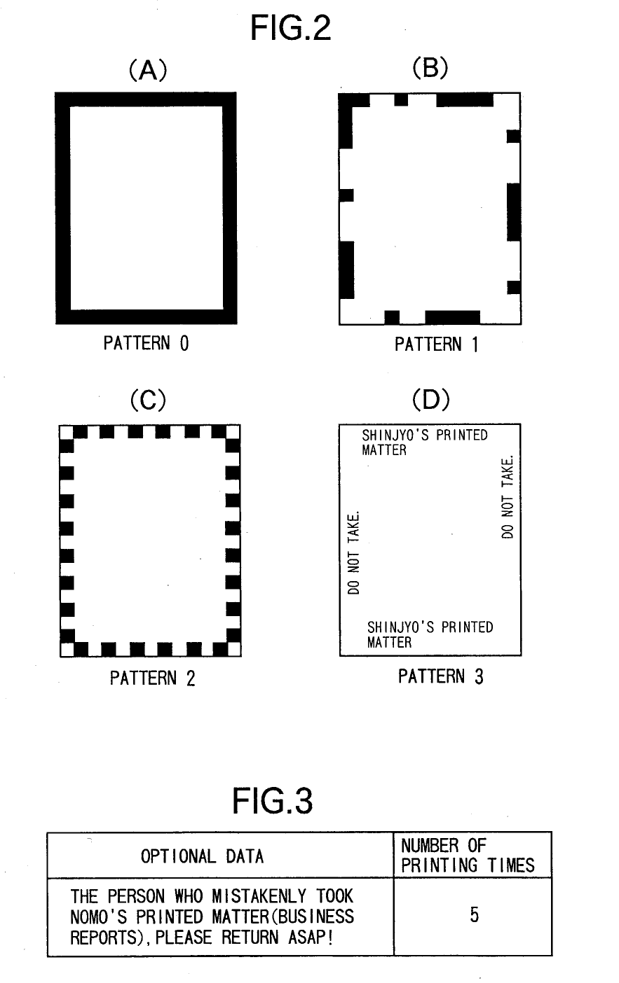

The pattern data, as shown in FIG. 2, is data for specifying a pattern to be printed on the margin of the division paper, and comprises not only a default pattern as shown in (A) of FIG. 2 but also arbitrary patterns such as shown in (B) through (D) of FIG. 2. Here, arbitrary patterns are appropriately registered corresponding for example to a pattern registration request from the client 30.

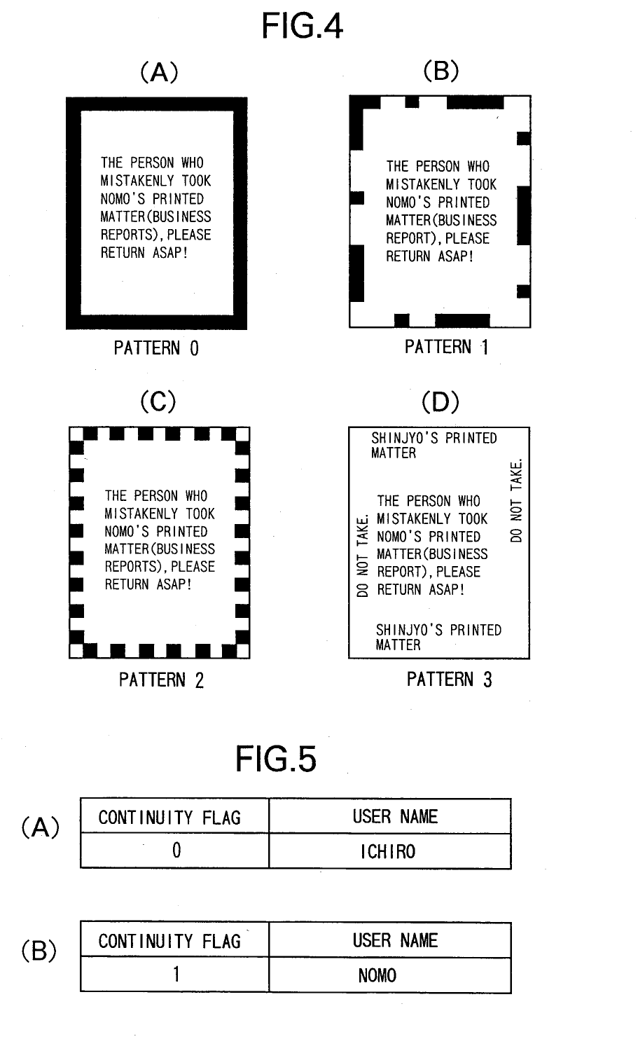

The optional data table, as shown in FIG. 3, comprises optional data and the number of printing times. The optional data, as shown in FIG. 4, is arbitrary data to be printed on the division paper, and comprises printable data such as text data and image data. Moreover, the number of times for printing optional data is set to the number of printing times. At this time, in order to reduce user's time and effort at set up, it is desirable to automatically set 1 as the default for the number of printing times.

The continuity determination table, as shown in FIG. 5, comprises a continuity flag to show user continuity, and a user name of the immediately preceding print request user. The continuity flag is a flag showing if the same user is printing continuously or not. For example, when the user is the same, this continuity flag is set to “0” (see (A) of FIG. 5) and when the user has changed, this continuity flag is set to “1” (see (B) of FIG. 5).

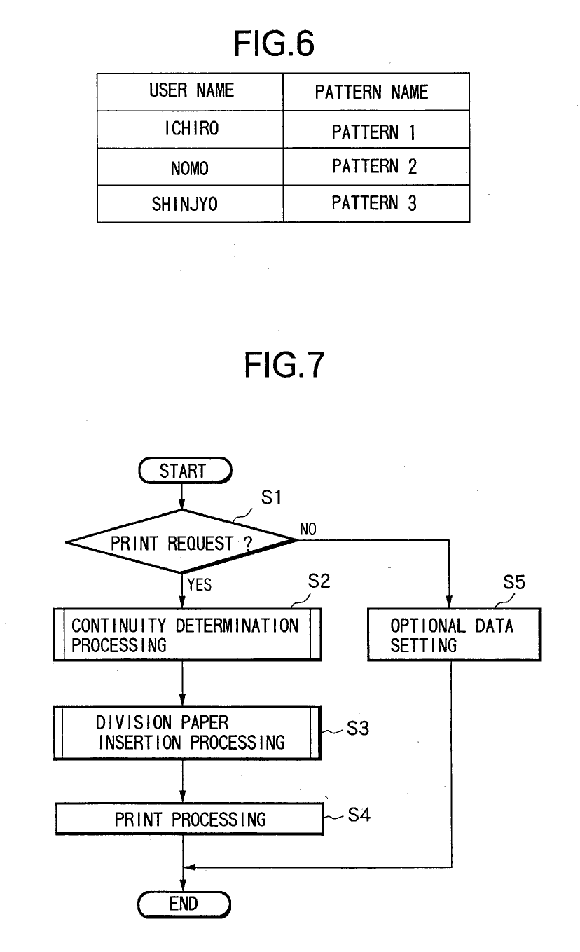

The division paper pattern table, as shown in FIG. 6, is a table for associating a print request user with a division paper pattern, and comprises a user name and a pattern data name of a pattern to be printed on the division paper. Here, a user name and a pattern data name are appropriately registered corresponding for example to a registration request from the client 30.

Next is a description of a processing to be executed in the printer server 10 when there is a print request or an optional data registration request from the client 30.

In FIG. 7 showing a main routine, in step 1 (abbreviated to “S1” in the figure, and similarly hereunder), it is determined whether or not a request from the client 30 is a print request. Then, if the request is a print request, control proceeds to step 2 (Yes), while if the request is not a print request, that is, it is an optional data registration request, control proceeds to step 5 (No).

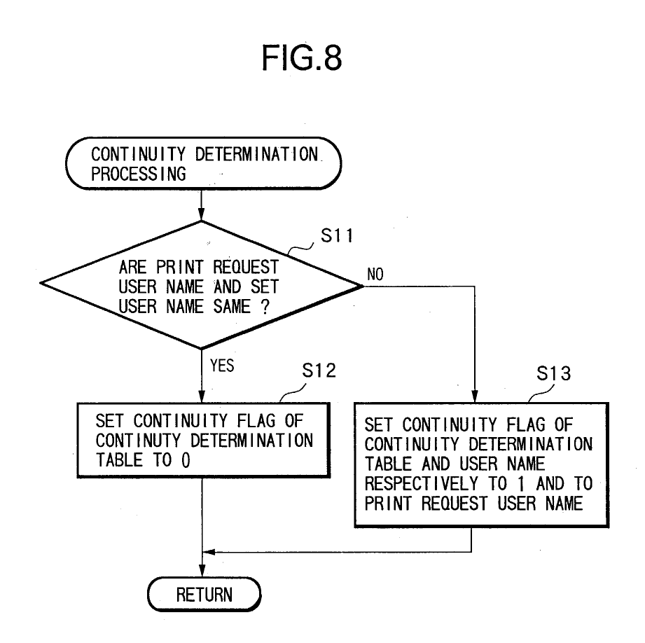

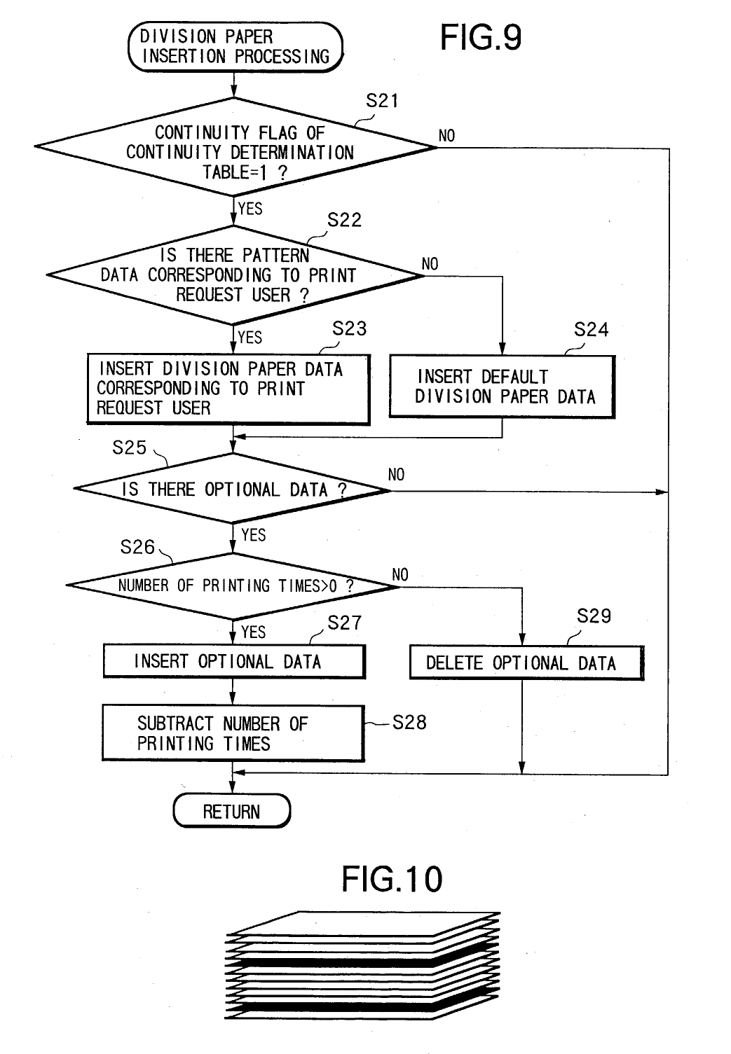

In step 2 through step 4, processing corresponding to the print request is executed. That is, in step 2, in order to determine whether or not a print request user has changed, a subroutine shown in FIG. 8 for executing continuity determination processing is called. In step 3, in order to insert division paper data into print data as required, a subroutine shown in FIG. 9 for executing division paper insertion processing is called. In step 4, print data (also including data into which division paper data is inserted) is output to the printing apparatus 20, and the print data then printed.

Here, the continuity determination processing shown in step 2 and FIG. 8 corresponds to the continuity determination means, the continuity determination function and the continuity determination step. Furthermore, the division paper insertion processing shown in step 3 and FIG. 9 corresponds to the division paper insertion means, the division paper insertion function and the division paper insertion step. Moreover, the processing in step 4 corresponds to the printing means, the printing function, the printing step, the print data output means, the print data output function and the print data output step.

On the other hand, in step 5 responding to an optional data registration request, optional data related to the optional data registration request, and the number of printing times thereof, are set in the optional data table of the DB 16 as shown in FIG. 3. At this time, when an optional data and the number of printing times thereof have already been set in the optional data table, it is desirable to be able to display to that effect, or to perform additional setting in list form. Here, the processing in step 5 corresponds to the optional data registration means and the number of times setting means.

FIG. 8 shows the subroutine for executing the continuity determination processing.

In step 11, it is determined whether or not a user name related to a print request user (referred to hereunder as “print request user name”) and a user name of the continuity determination table (referred to hereunder as “set user name”) are the same. Then, if the print request user name and the set user name are the same, control proceeds to step 12 (Yes), where, as shown in (A) of FIG. 5, the continuity flag of the continuity determination table is set to “0”. On the other hand, if the print request user name and the set user name are not the same, control proceeds to step 13 (No), where it is determined that the print request user has changed, and as shown in (B) of FIG. 5, the continuity flag of the continuity determination table is set to “1” and the print request user name is set as the set user name.

FIG. 9 shows the subroutine for executing division paper insertion processing.

In step 21, the continuity determination table is referred to and it is determined whether or not the continuity flag is set to 1. Then, if the continuity flag is set to 1, control proceeds to step 22 (Yes), while if the continuity flag is not set to 1, that is, it is set to 0, control returns to the main routine (No).

In step 22, the division paper pattern table is referred to and it is determined whether or not there is pattern data corresponding to a print request user, that is, whether or not a pattern data name associated with the print request user name has been set. Then, if there is pattern data corresponding to the print request user, control proceeds to step 23 (Yes), where division paper data appended with pattern data, is inserted into the print data. On the other hand, if there is no pattern data corresponding to the print request user, control proceeds to step 24 (No), where division paper data appended with default pattern data (see (A) of FIG. 2) is inserted into the print data.

In step 25, the optional data table is referred to and it is determined whether or not optional data has been set in the optional data table. Then, if optional data has been set, control proceeds to step 26 (Yes), while if optional data has not been set, control returns to the main routine (No).

In step 26, the optional data table is again referred to and it is determined whether or not the number of printing times is greater than 0. Then, if the number of printing times is greater than 0, control proceeds to step 27 (Yes), where, as shown in FIG. 4, the optional data is inserted into the division paper data. Afterwards, in step 28, the number of printing times is subtracted. On the other hand, if the number of printing times is 0, control proceeds to step 29 (No), where the optional data is deleted from the optional data table.

According to the above described series of processing, when the print request user has changed, then as shown in FIG. 10, division paper marked with a predetermined pattern on the margin thereof, is inserted before the first page of printed matter. Consequently, by merely flipping the edge of the printed matter, it becomes easy to sort printed matter for oneself from that of others, and hence the mistaking of printed matter of others can be greatly reduced. At this time, since a pattern corresponding to a print request user is marked on the division paper, it is possible to easily sort ones own printed matter even when printed matter of a plurality of users is accumulated in a paper-outlet tray.

Furthermore, since optional data can be arbitrarily marked on the division paper, it is possible for a user to convey a message urging, for example, someone using the same printing apparatus who might take mistakenly user's printed matter, to return that printed matter. Moreover, it is also possible to notify arbitrary messages such as mistaking, or maintenance information and the like to the person requesting printing. At this time, since the number of times for printing optional data can be arbitrarily set, such a situation where optional data is marked ad infinitum can be avoided.

Moreover, in the printing technique according to the present invention, since the division paper is printed using the print function of the printing apparatus, printing can be realized even with a printing apparatus that has only one paper-feed tray. Hence the cost for constructing the printing system can be suppressed.

If a program for realizing such functions is stored, for example, on a computer readable recording medium such as FD, CD-ROM, DVD-ROM or the like, and offered as a driver for a printer server, then the printing program according to the present invention can be distributed to the market place. Furthermore, a person who acquired such a recording medium can easily construct a printing system according to the present invention by installing the medium into a printer server.

What is claimed is:

1. A printing system comprising: continuity determination means for determining whether or not a user related to a print request has changed; division paper insertion means for inserting division paper data for division paper on which a predetermined pattern is marked on the margin thereof into print data when it is determined by said continuity determination means that a user related to a print request has changed; and print means for printing print data into which division paper data has been inserted by said division paper insertion means.

2. A printing system according to claim 1, further comprising pattern registration means for registering an arbitrary pattern associated with a user, wherein when a pattern for a user related to a print request is registered in said pattern registration means, said division paper insertion means marks this pattern on the margin of the division paper.

3. A printing system according to claim 1, further comprising optional data registration means for registering optional data to be marked on said division paper, wherein when optional data is registered by said optional data registration means, said division paper insertion means inserts this optional data into said division paper data.

4. A printing system according to claim 3, further comprising number of times setting means for setting the number of times for marking optional data on said division paper, wherein said division paper insertion means inserts the optional data into said division paper data by the number of times set by said number of times setting means.

5. A printing system comprising: continuity determination means for determining whether or not a user related to a print request has changed; division paper insertion means for inserting division paper data for division paper on which a predetermined pattern is marked on the margin thereof into print data when it is determined by said continuity determination means that a user related to a print request has changed; and print data output means for outputting to a printing apparatus, print data into which division paper data has been inserted by said division paper insertion means.

6. A printing system according to claim 5, further comprising pattern registration means for registering an arbitrary pattern associated with a user, wherein when a pattern for a user related to a print request is registered in said pattern registration means, said division paper insertion means marks this pattern on the margin of the division paper.

7. A printing system according to claim 5, further comprising optional data registration means for registering optional data to be marked on said division paper, wherein when optional data is registered by said optional data registration means, said division paper insertion means inserts this optional data into said division paper data.

8. A printing system according to claim 7, further comprising number of times setting means for setting the number of times for marking optional data on said division paper, wherein said division paper insertion means inserts the optional data into said division paper data by the number of times set by said number of times setting means.

9. A printing program for realizing on a computer: a continuity determination function for determining whether or not a user related to a print request has changed; a division paper insertion function for inserting division paper data for division paper on which a predetermined pattern is marked on the margin thereof into print data when it is determined by said continuity determination function that a user related to a print request has changed; and a print function for printing print data into which division paper data has been inserted by said division paper insertion function.

10. A printing program for realizing on a computer: a continuity determination function for determining whether or not a user related to a print request has changed; a division paper insertion means for inserting division paper data for division paper on which a predetermined pattern is marked on the margin thereof into print data when it is determined by said continuity determination function that a user related to a print request has changed; and a print data output function for outputting to a printing apparatus, print data into which division paper data has been inserted by said division paper insertion function.

11. A computer-readable recording medium recorded with a printing program for realizing on a computer: a continuity determination function for determining whether or not a user related to a print request has changed; a division paper insertion function for inserting division paper data for division paper on which a predetermined pattern is marked on the margin thereof into print data when it is determined by said continuity determination function that a user related to a print request has changed; and a print function for printing print data into which division paper data has been inserted by said division paper insertion function.

12. A computer-readable recording medium recorded with a printing program for realizing on a computer: a continuity determination function for determining whether or not a user related to a print request has changed; a division paper insertion function for inserting division paper data for division paper on which a predetermined pattern is marked on the margin thereof into print data when it is determined by said continuity determination function that a user related to a print request has changed; and a print data output function for outputting to a printing apparatus, print data into which division paper data has been inserted by said division paper insertion function.

13. A printing method of executing sequentially: a continuity determination step of determining whether or not a user related to a print request has changed; a division paper insertion step of inserting division paper data for division paper on which a predetermined pattern is marked on the margin thereof into print data when it is determined by said continuity determination step that a user related to a print request has changed; and a print step of printing print data into which division paper data has been inserted by said division paper insertion step.

14. A printing method of executing sequentially: a continuity determination step of determining whether or not a user related to a print request has changed; a division paper insertion step of inserting division paper data for division paper on which a predetermined pattern is marked on the margin thereof into print data when it is determined by said continuity determination step that a user related to a print request has changed; and a print data output step of outputting to a printing apparatus, print data into which division paper data has been inserted by said division paper insertion step.
